(19) United States
(12) Patent Application Publication
(10) Pub. No.: US 2004/0067395 A1
(43) Pub. Date: Apr. 8, 2004

(54) Fuel processing device, fuel cell power generation system and operation method thereof

(75) Inventors: Mitsuaki Nakata, Tokyo (JP); Mitsuie Matsumura, Tokyo (JP); Yoji Fujita, Tokyo (JP); Yoshiaki Odai, Tokyo (JP); Yoshihide Gonjo, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/426,874

(22) Filed: May 1, 2003

(30) Foreign Application Priority Data
Oct. 5, 2002 (JP) 2002-135691

(51) Int. Cl. H01M 8/06; H01M 8/04; B01J 8/02

(52) U.S. Cl. 429/19; 429/25; 422/211; 422/112

(57) ABSTRACT

A fuel processing device for converting a raw fuel fluid including hydrocarbon, alcohols, or ethers into a hydrogen fuel gas including hydrogen by a catalytic reaction, having one or more catalytic reactors each including a space maintaining a catalyst therein, with the catalytic reactor including deoxidizing means formed of a deoxidizing material, is provided.

### BACKGROUND OF THE INVENTION

1. Field of the Invention

The present invention relates to a fuel processing device and an operation method thereof, and more specifically to an economical fuel processing device in which oxygen invaded in the fuel processing device is removed, the safety and stability of the device are enhanced, and the necessity of purging inert gas can be greatly reduced or omitted, and an operation method thereof.

2. Description of the Related Art

FIG. 6 is a view to explain a conventional fuel processing device. For example, as shown in JP 05-251104 A, it is a main portion of the fuel processing device in which a raw fuel fluid consisting of hydrocarbon, alcohols, or ethers is converted into a reformed gas including hydrogen. In FIG. 6, reference numeral 1 denotes the fuel processing device; 1a, a reforming reaction portion that is a catalytic reactor; 1b, a shift reaction portion identically that is also the catalytic reactor; 2a, a reforming catalyst that is a main portion of the reforming reaction portion 1a; and 2b, a shift catalyst that is a main portion of the shift reaction portion 1b. Also, reference numeral 3 denotes a raw fuel supply system; 4, a steam supply system; and 5, an inert gas supply system. Reference numerals 6 to 9 denote interception valves, for example, automatic electromagnetic interception valves. The reforming reaction portion 1a converts hydrocarbon, alcohols or ethers into a reformed gas such as hydrogen, carbon monoxide, carbon dioxide, and methane by the action of the reforming catalyst. Also, the shift reaction portion 1b converts carbon monoxide in the reformed gas into carbon dioxide by the shift catalyst to reduce its amount. The shift reaction portion 1b is appropriately added according to the demand specification from a downstream instrument using hydrogen generated in the fuel processing device.

Note that the fuel processing device 1 is provided with a heating portion (a burner) for heating the reforming reaction portion 1a, a kind of heat exchanger, a desulfurizer, and the like which are not illustrated, and these are well known in the art.

In the reforming catalyst 2a, for example, an active metal of nickel or ruthenium is maintained on a multi-porous organism of the catalyst, and in the shift catalyst 2b, for example, an active metal of copper or iron is maintained on the multi-porous organism of the catalyst for the purpose of reaction promotion. For the stable operation of the fuel processing device 1, activities of these catalysts, especially active metals need, to be stably maintained for a long term.

The various catalysts usually have a micro-particle sized active metal required for the reaction dispersively maintained in a stable ceramic organism (for example, alumina, magnesia, zinc oxide, chromium oxide, etc). For the active maintenance, the maintenance of the micro-particle sized active metal is necessary. One of the specific means is to avoid oxidation and reduction cycles of the active metal under the discontinuous operation environment of the fuel processing device such as starting, operating and suspending. Therefore, in the conventional device as shown in FIG. 6, it is necessary that upon suspending the operation, the inert gas is purged from the inert gas supply system 5 in the catalytic reactor, a reaction gas component is removed and the inert gas is filled into the catalytic reactor. Also, such the inert gas purging has been necessary not only at the time of suspending the operation, but also at the time of suspending and safekeeping the fuel processing device for the purpose of exchanging the filled gas or supplying the gas with appropriate frequency in succession.

The main factor requiring the continuous purge by such an inert gas is the mixture of oxygen in air into the inside of the catalytic reactor, which is caused upon decreasing the temperature in the reaction portions 1a and 1b of the fuel processing device or upon suspending the operation thereof. For example, the reforming reaction portion 1a is usually operated at the temperature ranging from 500 to 800° C., and the shift reaction portion 1b is operated at the temperature ranging from 200 to 400° C. Upon decreasing the temperature from the reaction temperature after suspending the operation to, for example, the room temperature, when the temperature of the reaction gas inside the catalytic reactor is decreased with the interception valves 6 to 9 being closed and the inside being sealed, the internal pressure of the catalytic reactor is reduced by about 0.4 to 0.7 atmospheric pressure by the temperature drop. A similar tendency is shown even if the reaction gas inside the catalytic reactor is just filled as it is or even if the inert gas such as nitrogen is filled.

On the other hand, considering cost performance, it is not practical to demand the gas sealing property like a vacuum container from a closing valve and a general-purpose joint portion manufactured on an industrial scale in order to avoid the mixture of oxygen in air inside the catalytic reactor. Accordingly, in these circumstances, it has been impossible to prevent oxygen in the atmosphere from entering it from the portion where gas sealing property is not enough in the long term. FIG. 7 is a view showing a change with time of the oxygen concentration of gas sealed spaces (reforming catalyst 2a, shift catalyst 2b and conduit system to connect thereto) in which the interception valves 6, 7, 8 and 9 are closed after the operation has been stopped to purge the inert gas (nitrogen gas) and the nitrogen gas is then filled in the conventional fuel processing device. In FIG. 7, the oxygen concentration is 0 just after purging, but gradually increased as the suspending time passes. In this system the concentration is about 1 cc/hour when converted into invasion rate of oxygen. In this test, internal pressures of the gas sealed spaces are identical to the outside air, and the above oxygen invasion occurs due to diffusion phenomenon based on an oxygen partial pressure difference between the inside and the outside. Also, in the example where the decompressed condition is left to continue, when the airtightness is not enough, about 500 cc of oxygen is absorbed in the fuel processing device for use in this test during the time period of temperature drop, for example, around 20 hours. The invasion rate is 25 cc/hour when converted into the value per hour, and it is necessary to consider one digit higher invasion rate compared to the invasion rate by diffusion.

Also, in a fuel processing plant, automatic interception valves that are automatically opened or closed are generally used in many cases. However, in a general-purpose cheap electromagnetic interception valve, it is necessary to consider the risk concerning the reliability of closing. That is, in the electromagnetic interception valve, though the tightening action by a spring is general, a sufficient closing torque is not obtained compared to a manual interception valve and the incomplete closing occurs in some cases. For example, in one example of the test by the present inventors using the electromagnetic interception valve, the example showing the insufficient closing was observed about once in 100 to 200 tests. Specifically, a valve is not vertically moved on a valve seat, and remains on the way to provide a gap. In that case, the oxygen invasion rate or quantity of invasion equal to or more than numerical value shown in FIG. 7 is required to be considered.

From the above situation, when the fuel processing device stops its operation for a long term, in order to prevent the oxygen invasion by diffusion phenomenon or the pressure-reduction absorption through the portion that hardly withstands the decompressed condition originally in terms of performance or the portion where the execution/action are not enough, the inert gas purge is required to be continuously performed with a suitable frequency upon suspending its operation (upon decreasing the temperature) or upon suspending and safekeeping the fuel processing device. Accordingly, a control power supply had to be always operated.

Such a continuous inert gas purge causes the cost of incidental facilities to increase and limits the operation performance of the fuel processing device by the arrangement of the gas cylinder and thus, the fuel processing device becomes difficult to generally use. For example, the fuel processing device for generating hydrogen from a portable fuel such as methanol, dimethyl ether, or propane gas is expected as a portable power supply or a mobile power supply such as an automotive power supply in combination with the fuel cell. However, because the necessity for accompanying the inert gas causes the application of the fuel cell power supply with the fuel processing device to be difficult, the development of the fuel processing device in which the necessity of the inert gas purge can be greatly reduced or eliminated is desired.

The use of the noble metal catalyst which is superior in the antioxidation characteristic that is stable against the air oxidation as one means for solving such problems is studied. In the fuel processing device having a reforming reaction portion and a shift reaction portion, in particular, the copper-based shift catalyst broadly used in the shift reaction portion is weak against the invasion of oxygen. Therefore, the shift catalyst using a noble metal, for example, platinum is developed instead of the copper-based catalyst. As the reforming catalyst, the methanol reforming catalyst which uses a noble metal such as palladium as one example is also developed similarly in stead of a copper-based methanol reforming catalyst. Note that, though a steam reforming catalyst using nickel or ruthenium is given a relatively slight influence by the mild oxidation caused by small amount of invaded oxygen, but when activation/stop of the fuel processing device is repeated many times, sintering of metal particles is promoted in the long term, and its activity is apt to be easily lowered, and thus, the development of the noble metal catalyst is advanced for this. However, the noble metal catalyst is expensive by around one digit or more as compared to the conventional catalyst in which general-purpose copper-based, nickel-based, or iron-based one is used for the active metal, and problems concerning cost performance arise and none of those is put into practical use.

As described the above, in the conventional fuel processing device, the catalytic reactor is needed to be continuously purged with the inert gas upon suspending the operation or upon suspending and safekeeping the device to protect the catalyst from oxygen in air, and such situations limit the application range of the fuel processing device and prevent the general use thereof.

### SUMMARY OF THE INVENTION

Accordingly, it is an object of the present invention to provide a fuel processing device which can remove oxygen that enters the fuel processing device to enhance safety and stability of the device and can significantly remove or eliminate necessity of an inert gas purge with a high cost performance and an operation method thereof.

With the above object in view, the present invention is directed to a fuel processing device for converting a raw fuel fluid including hydrocarbon, alcohols, or ethers into a hydrogen fuel gas including hydrogen by a catalytic reaction. The device has one or more catalytic reactors each including a space maintaining a catalyst therein and the catalytic reactor includes deoxidizing means formed of a deoxidizing material. As a result, oxygen that enters the fuel processing device can be removed, and safety and stability of the device can be increased. Moreover, necessity of an inert gas purging can be significantly reduced or eliminated, and thus the fuel processing device having a good cost performance is provided.

Further, the present invention is directed to an operation method of a fuel processing device that converts a raw fuel fluid including hydrocarbon, alcohols, or ethers into a hydrogen fuel gas including hydrogen by a catalytic reaction and has one or more catalytic reactors each including a space maintaining a catalyst therein. The catalytic reactor includes deoxidizing means formed of a deoxidizing material, and the method includes keeping the catalytic reactor in a sealed state when the fuel processing device stops an operation and maintaining the inside of the catalytic reactor under a reductive gas atmosphere. As a result, oxygen that enters the fuel processing device can be removed, and safety and stability of the device can be increased. Moreover, necessity of an inert gas purging can be significantly reduced or eliminated, and thus the operation method of the fuel processing device having a good cost performance can be provided.

Furthermore, the present invention is directed to another operation method of a fuel processing device that converts a raw fuel fluid including hydrocarbon, alcohols, or ethers into a hydrogen fuel gas including hydrogen by a catalytic reaction and has one or more catalytic reactors each including a space maintaining a catalyst therein. The catalytic reactor includes deoxidizing means formed of a deoxidizing material and the method includes keeping the catalytic reactor in a sealed state when the fuel processing device stops an operation and maintaining the inside of the catalytic reactor under an inert gas atmosphere. As a result, oxygen that enters the fuel processing device can be removed, and safety and stability of the device can be increased. Moreover, necessity of an inert gas purging can be significantly reduced or eliminated, and thus the operation method of the fuel processing device having a good cost performance can be provided.

Still further, the present invention is directed to a fuel cell power generation system. The system has a fuel processing device for reforming a raw fuel supplied from a raw fuel supply source to a fuel gas by a catalyst; a fuel cell device in which the fuel gas generated in the fuel processing device is allowed to flow into a fuel gas flow passage and an oxidant gas supplied from outside is allowed to flow into an oxidant gas flow passage to cause a chemical reaction between the fuel gas and the oxidant gas to generate an electricity; a fuel gas conduit provided between the fuel processing device and the fuel cell device for circulating the fuel gas; a plurality of opening and closing valves each provided at a predetermined place of the fuel gas conduit for changing at least a predetermined catalytic reaction portion of the fuel processing device between a sealed state and a state capable of communication; and a gas storage device communicated with a sealed and communicable space for absorbing a change in the pressure of gas in the sealed and communicable space and for storing the gas therein. As a result, even if the volume of gas in the sealed and communicable space including the catalytic reaction portion is changed, the volume of the gas storage device changes automatically as the volume of gas in the above-mentioned space is changed, and thus pressure change in the sealed and communicable space can be absorbed, and an inflow of air can be blocked. Thus, unmanned operation of the temperature-decreasing process of the system is possible, and monitoring internal pressures in the process of decreasing temperature or suspending the operation, and also supply of purge gas are not required, so that the low-priced and simple device can be provided, and also the high reliable power generation system can be provided.

Yet further, the present invention is directed to another fuel cell power generation system. The system has a fuel processing device for reforming a raw fuel supplied from a raw fuel supply source to a fuel gas by a catalyst; a fuel cell device in which the fuel gas generated in the fuel processing device is allowed to flow into a fuel gas flow passage and an oxidant gas supplied from outside is allowed to flow into an oxidant gas flow passage to cause a chemical reaction between the fuel gas and the oxidant gas to generate an electricity; a fuel gas conduit provided between the fuel processing device and the fuel cell device for circulating the fuel gas; a plurality of opening and closing valves each provided at a predetermined place of the fuel gas conduit for changing at least a predetermined catalytic reaction portion of the fuel processing device between a sealed state and a state capable of communication; and a pressure adjustment mechanism communicated with a sealed and communicable space for adjusting the pressure of gas in the sealed and communicable space to be equal to or higher than the pressure outside the fuel processing device. As a result, even if the volume of gas in the sealed and communicable space including the catalytic reaction portion is changed, the pressure adjustment mechanism adjusts automatically the pressure to be equal to or higher than the pressure outside the fuel processing device, and thus an inflow of air from the outside can be blocked. Thus, unmanned operation of the temperature-decreasing process of the system is possible, and monitoring internal pressures in the process of decreasing temperature or suspending the operation, and also supply of purge gas are not required, so that the low-priced and simple device can be provided, and also the high reliable power generation system can be provided.

### BRIEF DESCRIPTION OF THE DRAWINGS

The following description, given by way of example, will best be understood in conjunction with the accompanying drawings in which:

FIG. 1 is a diagram for explaining a fuel processing device in accordance with Embodiment 1 of the present invention;

FIG. 2 is a graph for showing a life test result of oxidation and reduction cycles (operation and stop cycles) in a low concentration oxygen state of a copper-based shift catalyst;

FIG. 3 is a diagram for explaining a fuel processing device in accordance with Embodiment 2 of the present invention;

FIG. 4 is a diagram for explaining a fuel processing device in accordance with Embodiment 3 of the present invention;

FIG. 5 is diagram for explaining a fuel processing device in accordance with Embodiment 4 of the present invention;

FIG. 6 is diagram for explaining a conventional fuel processing device;

FIG. 7 is a graph for showing a change with time in the oxygen concentration of a gas sealed space after suspending the operation and purging a nitrogen gas in the conventional fuel processing device;

FIG. 8 is a diagram for explaining a fuel processing device in accordance with Embodiment 5 of the present invention;

FIG. 9 is a graph for showing a life test result of oxidation and reduction cycles (operation and stop cycles) in a low concentration oxygen state of a copper type shift catalyst;

FIG. 10 is a view for explaining a fuel processing device in accordance with Embodiment 6 of the present invention;

FIG. 11 is a diagram for showing a change with time in the oxygen concentration of a gas sealed space after suspending the operation and purging a nitrogen gas in the conventional fuel processing device;

FIG. 12 is a block diagram showing the constitution peripheral to the fuel processing device of the fuel cell power generation system in accordance with Embodiment 8 of the present invention;

FIG. 13 is a graph for showing internal pressure of catalytic reaction portion upon suspending an operation and the fall situation of temperature; and

FIG. 14 is a block diagram showing the constitution peripheral to the fuel processing device of the fuel cell power generation system in accordance with Embodiment 9 of the present invention.

### DETAILED DESCRIPTION OF A PREFERRED EMBODIMENTS

Embodiment 1

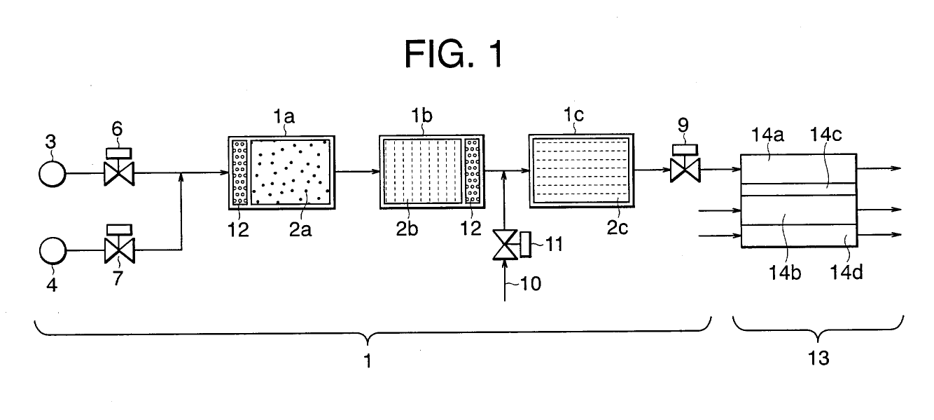

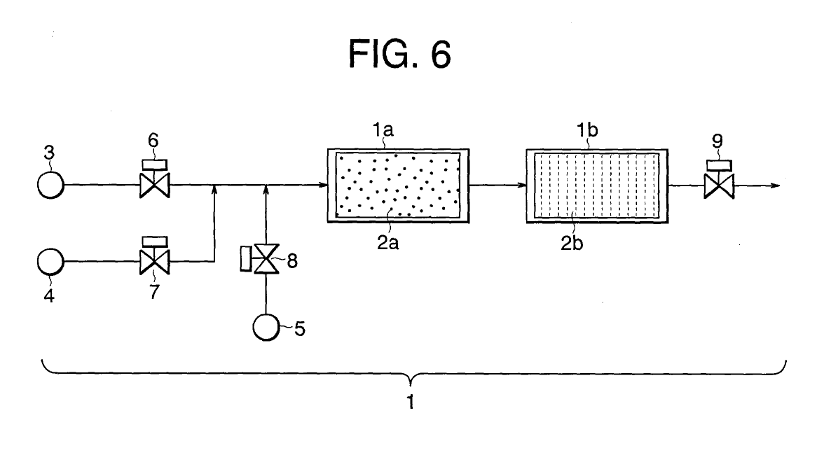

FIG. 1 is a view for explaining a fuel processing device in accordance with Embodiment 1 of the present invention. In FIG. 1, each reference symbol identical to that of the conventional device of FIG. 6 means the same component, and reference numeral 1 denotes a fuel processing device; 1a, a reforming reaction portion; 1b, a shift reaction portion; 2a, a reforming catalyst; 2b, a shift catalyst; 3, a raw fuel supply system; and 4, a steam supply system. Reference numerals 6 to 9 denote interception valves, and as an example, automatic electromagnetic interception valves. In this embodiment, two stages of the shift reaction portion 1b and a selective oxidation CO removal reaction portion 1c are provided as a removal process of carbon monoxide. Reference numeral 10 denotes an air supply system for selective oxidation that supplies the air required for a selective oxidation CO removal reaction; 11, an interception valve; and 12, deoxidizing means consisting of a deoxidizing material. Reference numeral 13 denotes a fuel cell device generating electricity using hydrogen produced in the fuel processing device, and a polymer electrolyte fuel cell device is exemplified in this embodiment. Reference symbol 14a denotes a fuel gas flow passage of the fuel cell device 13; 14b, an oxidation gas flow passage; and 14c, a fuel cell sandwiched by both gas flow passages. Reference symbol 14d denotes a cooling refrigerant passage for cooling the fuel cell device.

The reforming reaction portion 1a, the shift reaction portion 1b and the selective oxidation CO removal reaction portion 1c of the fuel processing device 1 in this embodiment can be operated similar to the conventional method, and a hydrocarbon-based raw fuel fluid consisting of hydrocarbon, alcohols or ethers (dimethyl ether, etc.) is converted into a hydrogen fuel gas including hydrogen. In the shift reaction portion 1b, for example, a copper-based shift catalyst is filled up, and the CO concentration is reduced to around 0.5 to 1%. In the selective oxidation CO removal reaction portion 1c in this embodiment, an outside air is freshly introduced by the air supply system 10 for selective oxidation, CO is selectively oxidized by the action of the selective oxidation catalyst 2c, and the CO concentration is reduced to, for example, 10 ppm or less.

In this embodiment, the fuel processing device 1 upon suspending the operation causes the catalytic reactor consisting of the reforming reaction portion 1a, the shift reaction portion 1b and the selective oxidation CO removal reaction portion 1c to be a sealed state and the inside of the catalytic reactor is maintained under the reductive gas atmosphere. Specifically, the reforming reaction portion 1a, the shift reaction portion 1b, the selective oxidation CO removal reaction portion 1c and the inside of the instrument/conduit communicating thereto are sealed under the fuel gas atmosphere by closing the interception valves 6, 7, 9 and 11. In that case, as described earlier, the invasion of oxygen from the atmosphere to the catalytic reactor is needed to be permitted to some extent by the realistic limitation of the airtightness in the interception valves, a joint portion, etc. Such an invasion of oxygen is principally allowed in case of the fuel processing device of FIG. 1 by the interception valve 9 or 11. The interception valve 11 is clearly adjacent to air. Though the interception valve 9 is connected to the fuel gas flow passage 14a of the fuel cell device 13 and is not directly in contact with the atmosphere, oxygen may invade the fuel gas flow passage 14a by the following reason: first of all, upon suspending the operation of the fuel processing device 1, there is the case which introduces air into the fuel gas flow passage 14a to generate a purged gas, or upon suspending the operation and safekeeping, the gas interception characteristic between the fuel side and air side is lowered when the fuel cell 14c is dried and the oxygen movement from the oxidation gas flow passage 14b to the fuel gas flow passage 14a is seen, or the fuel gas flow passage 14a is a circulation system and oxygen is easily flowed backward when an outlet side of the fuel gas flow passage 14a communicates with the atmosphere. The interception valve 6 is connected to the raw fuel supply system 3 and air is generally hard to invade it. About the interception valve 7, the air invasion possibility upon suspending the operation should be considered or not by the structure of the steam supply system 4 on the upstream side. For example, the fear of an air invasion is eliminated when the steam supply system 4 is filled with water upon suspending the operation. There is a risk of the air invasion when the steam supply system 4 is connected to a steam boiler and becomes near to the vacuum state upon suspending the operation. From the above reasons, in the device of FIG. 1, it is thought that interception valves 7, 9, and 11 cause oxygen to invade the inside of the catalytic reactor.

Secondly, to apply the present invention, the catalyst to be protected from invasion oxygen should be needed to be specified. In the fuel processing device 1 as shown in FIG. 1, the catalyst to be protected from invasion oxygen is defined as the reforming catalyst and the shift catalyst. The use of a platinum-based catalyst is assumed about the catalyst in the selective oxidation CO removal reaction portion, and the protection of catalyst is made unnecessary. The decision as to whether the protection of catalyst is necessary or useless is made based on whether the catalyst material is easily oxidized by oxygen to lose its activity or not at the temperature (generally, room temperature in many cases) near the temperature upon suspending the fuel processing device, or whether the catalyst activity is lost or not in the long term by oxidation and reduction cycles.

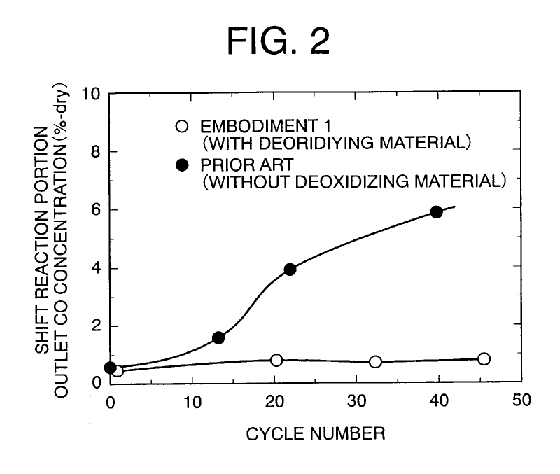

FIG. 2 is a chart showing a life test result of oxidation and reduction cycles (operation and stop cycles) in a low concentration oxygen state of a copper-based shift catalyst. In the life test of the operation and stop cycles, a cycle that the reformed gas such as hydrogen, carbon monoxide, carbon dioxide, or methane is supplied in the catalytic reactor (shift reaction portion) including the general copper-based shift catalyst, an operation is conducted 230° C., the CO concentration of an outlet portion of the shift reaction portion is measured, successively, as the reproduction of the operation stop state, the temperature in the shift reaction portion is decreased to the room temperature after the inside of the shift reaction portion is set as a gas atmosphere including oxygen of the low oxygen concentration (equivalent to the conventional example involving the invasion oxygen), suspending and maintaining operations are performed at room temperature for a while, and the operation starts again is defined as one cycle, and this cycle is repeated plural times to measure the CO concentration of the outlet portion of the shift reaction portion. This test result is shown as black circles in FIG. 2. After the operation and stop cycle is repeated around 10 times, it becomes impossible to remove the carbon monoxide down to 1% or less, which is required for the function. From the above, it is understood that the protection of a catalyst is needed for invasion oxygen by the copper-based shift catalyst. On the other hand, the platinum-based selective oxidation CO removal catalyst is materially superior in an antioxidation characteristic and the conspicuous change is not observed by a similar test. As another type, though ruthenium is used as the selective oxidation CO removal catalyst, the catalyst protection is desirable because ruthenium is generally easily oxidized compared with platinum and inferior thereto in the life characteristic of the operation and stop cycles. In any case, the life test of the operation and stop cycles as described formerly is performed per catalyst to be applied, the sensitivity of the catalyst against oxygen is examined, and the invasion oxygen concentration and the target number of operation and stop cycles of the fuel processing device is considered to determine the necessity of the protection against the invasion oxygen.

As described above, according to this embodiment, because the reforming catalyst 2a and the shift catalyst 2b are decided as the catalysts to be protected against the invasion oxygen, the deoxidizing means 12 consisting of a deoxidizing material are provided in two places of an inlet portion of the reforming reaction portion 1a and an outlet portion of the shift reaction portion 2b which constitute fluid paths that is invaded by oxygen and allows it to reach the catalyst. For this fuel processing device 1, the operation and stop cycle life test similar to the above case is performed. According to this embodiment, as shown in white circles of FIG. 2, it is understood that the removal of CO down to 1% or less functionally required can be stably achieved regardless of the frequency of the operation and stop cycles. In this way, in this embodiment, even if the gas purge by the inert gas is omitted, the deterioration of the catalyst by the invasion oxygen can be prevented and the catalyst can be stably operated for a long term.

Another feature of this embodiment is to increase the safety of the fuel processing device omitting the purge by the inert gas. To completely prevent the invasion oxygen by 100% and to seal up with the fuel gas atmosphere are possible in principle, but practically difficult. On the other hand, though it is relatively easy to restrain an invasion quantity of oxygen to a small amount, oxygen coexists in the raw fuel fluid or the inflammable gas such as the reformed gas, and has the problem in security. According to this embodiment, by predicting the quantity of oxygen invasion to the catalytic reactor and providing the deoxidizing means for removing the oxygen according to the invasion prediction quantity, oxygen does not substantially coexist in the inflammable gas atmosphere, and it is cheap as well as safe.

In the above embodiment, though the deoxidizing means 12 consisting of the deoxidizing material are provided at two places of the inlet portion of the reforming reaction portion 1a and the outlet portion of the shift reaction portion 2b, it is desirable from the security point of view to provide deoxidizing means 12 at all the places with the possibility that oxygen invades. In the above-mentioned form of FIG. 1, though the deoxidizing means 12 is not arranged at the outlet portion of the selective oxidation CO removal reaction portion 1c adjacent to the interception valve 9 while putting emphasis on the catalyst protection, the deoxidizing means 12 can be also installed in this place as needed, and in that case, the more safety and stable operation of the catalyst are secured simultaneously.

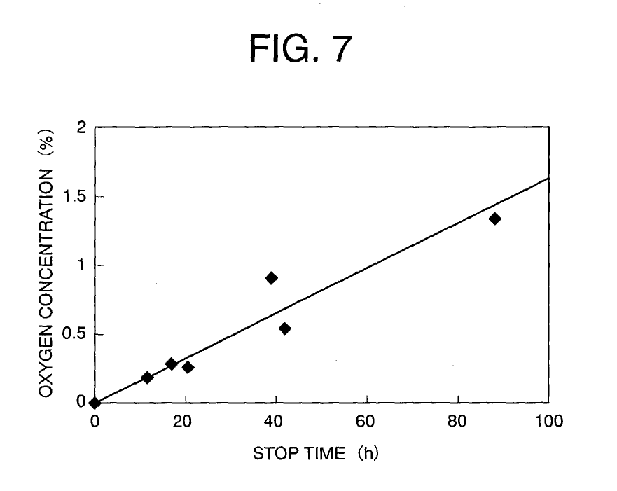

In the present invention, one example of the deoxidizing material constituting the deoxidizing means 12 is a combustion catalyst. In this embodiment, because the catalytic reactor is sealed without purging by the nitrogen gas, combustible components such as hydrogen or carbon monoxide exist in the catalytic reactor. It is necessary for the combustion catalyst to remove the invasion oxygen with the combustible component (hydrogen or carbon monoxide) through combustion upon a high temperature or upon suspending the operation in this embodiment. For this purpose, the combustion catalyst primarily should be chosen, which is suitable for the usage condition. In case where the operation stop temperature or safekeeping temperature of the fuel processing device is a room temperature, as the combustion catalysts, palladium or platinum-supported catalysts having enough activities at near the room temperature are preferable, and, for example, the deoxidation catalyst for a gas refinement for use in a high purity gas refinement for a semiconductor process is available. In particular, the combustion catalyst using palladium can burn and remove oxygen at the low temperature equal to or less than 0° C., and is suited, for example, for the fuel processing device used in cold districts. By the use of such a combustion catalyst, the oxygen concentration inside the catalytic reactor generally can reduced to a very small amount equal to or less than 0.01 mol %. In this case, because the quantity of oxygen invading the catalytic reactor is a small quantity, the charging quantity of the combustion catalyst is accordingly determined to fill the catalyst thereinto at the small quantity. Specifically, the quantity of oxygen invasion may be calculated back from the test, for example, of FIG. 7 showing the above-mentioned conventional example, or a gas leakage test of the reactor/conduit systems, and the result may be substituted for the oxygen invasion rate, namely, the demanded combustion rate to determine the necessary quantity of combustion catalyst. Also, as other combustion catalysts, a three-way catalyst that a transition metal such as nickel or a rare earth metal is combined with platinum, the catalyst using a composite oxide of silver though its appropriate operation temperature becomes slightly high temperature of around 100° C. or more, and other inexpensive low temperature operation type combustion catalysts are developed, and can be applied according to safekeeping temperature upon suspending the operation of the fuel processing device.

Note that, in constitution of the fuel processing device shown in FIG. 1, the deoxidizing material is directly exposed to the operation temperature or a gas atmosphere of the catalytic reactor upon the operation of fuel processing device 1. Therefore, as for the deoxidizing material, it is necessary to select the most suitable material according to an operation condition of the catalytic reactor. For example, the deoxidizing material arranged in the outlet portion of the shift reaction portion 1b is exposed to the gas atmosphere including carbon dioxide or a steam including hydrogen as a main component under, for example, 200 to 300° C. upon the operation of fuel processing device 1. However, in particular, there is not a problem if a low temperature operation type combustion catalyst is selected. The deoxidizing material arranged in the inlet portion of the reforming reaction portion 1a is exposed to the atmosphere including hydrogen reversely diffused from the reforming catalyst 2a and including a hydrocarbon or steam as a main component under, for example, around 400 to 500° C. upon the operation of the fuel processing device 1. When the heat-resistance of a low temperature operation type combustion catalyst is concerned, some device is required, with which the deoxidizing material is separated or somewhat remotely disposed from the reforming catalyst 2a to relax the influence of heat for the combustion catalyst. Also, the combustion catalyst inferior in the low temperature oxidation characteristic to some extent but superior in heat-resistance may be selected. Furthermore, in the embodiment shown in FIG. 1, because the deoxidizing means 12 and the reforming catalyst 2a are unified, the catalyst is so selected that the hydrocarbon which is a kind of a raw fuel fluid is not excessively reacted therewith and secondary reaction such as the carbon deposition does not occur, and then it is necessary to confirm this. Also, when there is a risk of the secondary reaction, such that it is effective to relax the influence of heat for the combustion catalyst the deoxidizing material is disposed remotely from the catalytic reactor.

Embodiment 2

As other kinds of the deoxidizing material, the deoxidizing material of a type easily oxidized by oneself to remove oxygen, such as metal powders such as iron powders or copper powders or a molding of metal powders and a ceramic (hereinunder called auto-oxidizable deoxidizing material) is also available. The auto-oxidizable deoxidizing material using, for example, iron powders is broadly utilized for preventing the food from being oxidized as the deoxidizing material working at room temperature. Such the deoxidizing material can remove oxygen inside the catalytic reactor at room temperature down to around 0.1 mol % or less, and can be applied to the present invention.

However, the auto-oxidizable deoxidizing material has the characteristic that it is extremely easily oxidized itself, and the consideration is necessary for an application. It has been oxidized by oneself when maintained in an oxidizing atmosphere gas before functioning as the deoxidizing material, and its activity is lost. With respect to the embodiment shown in FIG. 1, the deoxidizing material maintained in the outlet portion of the shift reaction portion 1b is always maintained in the reductive gas while the fuel processing device 1 operates or stops and has no above problems. However, the operation temperature is 200° C., which is slightly high and it is necessary to pay attention to sintering. On the other hand, in the deoxidizing material maintained in the inlet portion of the reforming reaction portion la, the operation temperature is 400° C., which is much higher temperature, hydrogen is diluted upon operation of the fuel cell (there is only hydrogen reversely diffused from the reforming catalyst maintenance layer 2a), and use of the auto-oxidizable deoxidizing material is not generally suited.

On the contrary, the feature of the auto-oxidizable deoxidizing material is that the existence of an inflammable gas (for example, hydrogen or carbon monoxide) is unnecessary as a circumferential atmosphere gas, and even if the circumferential atmosphere is an inflammable gas or an inert gas, it exerts a function. Embodiment 1 described above is an example in which a gas purge with the inert gas is completely eliminated, and though the combustion catalyst type or the auto-oxidizable deoxidizing material is also available together, it is necessary to apply the auto-oxidizable deoxidizing material instead of the deoxidizing material of the combustion catalyst type about the fuel processing device which allows for the inert gas purge.

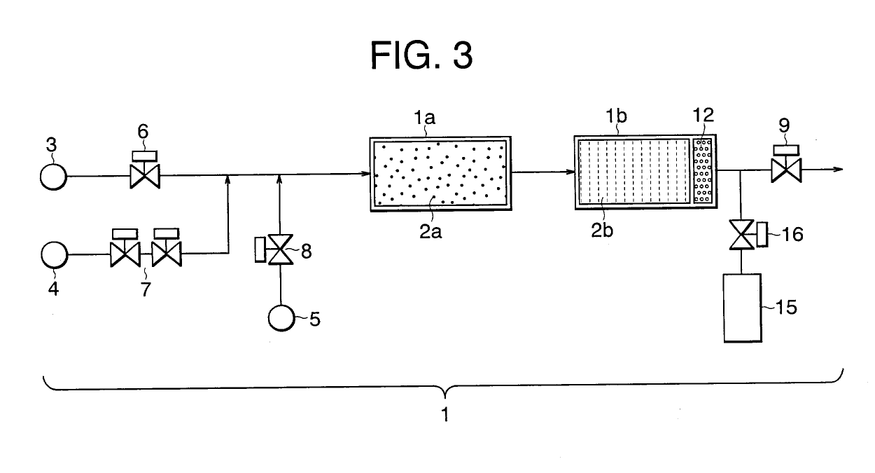

FIG. 3 is a view for explaining the fuel processing device performing the inert gas purge. In FIG. 3, though reference numerals 1 to 12 are similar to those of the embodiment of FIG. 1, an auto-oxidizable deoxidizing material is used for the deoxidizing means 12. Reference numeral 15 denotes a pressure adjustment mechanism adjusting the pressure inside the fuel processing device 1, and reference numeral 16 denotes an interception valve to accompany pressure adjustment mechanism 15.

The operation is explained as follows. In the fuel processing device 1 of FIG. 3, it is assumed that the hydrogen generated by the reforming reaction portion 1a is supplied from a hydrocarbon-based fuel to the phosphoric acid-based fuel cell. When use with the phosphoric acid fuel cell is intended, CO removal mechanism of the reformed gas is sufficient only with the shift reaction portion 1b. In the shift reaction portion 1b by oneself, the CO concentration can be reduced to 0.5 mol% or less, which meets the operation requirement of the phosphoric acid fuel cell (about 1 mol % or less).

Upon suspending the operation of the fuel processing device 1, after closing the interception valves 6, 7, at first the inert gas (for example, nitrogen) is supplied from the inert gas supply system 5 through the interception valve 8 to exhaust the raw fuel gas or the reformed gas maintained by the reaction portions 1a, 1b and conduit systems, etc. Then, all the interception valves 6, 7, 8, and 9 of fuel processing device 1 are closed to form a sealed space of the inert gas and change the state to a decrease state of temperature (in this case, only interception valve 16 is kept an open state). In the decrease state of temperature, the reaction portions 1a, 1b or conduits, etc. that are in a high temperature state (for example, 200 to 800° C.) upon the operation start to decrease the temperature and finally reach the maintenance temperature upon suspending the operation (for example, room temperature). In this case, an internal pressure of the device is normally reduced by the temperature drop and decompressed to, for example, around minus 0.5 atmospheric pressure when there is not especially a device (according to so-called Boyle-Charles' law). In this embodiment, the pressure adjustment mechanism 15 which can make adjustment such that the pressure inside the catalytic reactor (internal pressure) is substantially identical to the pressure outside the catalytic reactor (external pressure) is added to make a feature of the present invention using the deoxidizing means 12 more effectively. The pressure adjustment mechanism 15 adjusts the internal pressure to be almost identical to the external pressure, by self-adjusting the capacity automatically based on a difference of the internal pressure and external pressure with a gas storage space formed by, for example, bellows and a water seal. Alternatively, another type of the pressure adjustment mechanism 15 is a mechanism including a control system in which an internal pressure is measured, a capacity is mechanically adjusted according to a measurement result and the internal pressure is always kept identical to the external pressure (an atmospheric pressure). By arranging this pressure adjustment mechanism 15, difference in pressure between the inside and the outside is substantially kept zero and the invasion quantity of oxygen by absorption can be substantially eliminated. That is, a mixing process of oxygen is limited to only mixture by a diffusion phenomenon caused by the difference between the internal and external oxygen partial pressures. As a result, as described in the conventional example, the oxygen mixing rate can be reduced by around one or two digits and a load on the deoxidizing means 12 can be greatly reduced. That is, a charging quantity of the deoxidizing material can be reduced to around 1/10 to 1/100, and an equivalent effect can be obtained with compact deoxidizing means 12.

Also, in the embodiment of FIG. 3, the interception valves 7 are serially connected in two stages, and the operation reliability and sealing property of interception valves 7 are improved. The provision of deoxidizing means 12 to the reforming reaction portion 1a is thus omitted. As described earlier, though it is necessary to apply the auto-oxidizable deoxidizing material in this embodiment in which the inert gas purge is conducted, because the auto-oxidizable deoxidizing material is not generally suitable for relatively high temperature the operation environment with dilute hydrogen, and the reforming catalyst is not sensitive to the oxidation as compared with the shift catalyst, the provision of deoxidizing means 12 is omitted by improving the seal performance of interception valve 7.

Here, advantages of the inert gas purge are that water (steam) or a combustible component contained in the indispensable reaction gas for the reforming reaction or the shift reaction can be removed, and that the bad influence to the catalyst and conduit materials by the dew condensation when the temperature drops under the steam atmosphere can be excluded, or that an essential insecurity with suspending the operation while maintaining an inflammable gas can be removed. According to the effects of this embodiment, a continuous inert gas purge to avoid a pressure reduction during a decrease of temperature that is conventionally necessary or an appropriate addition of the inert gas purge during a maintenance period at room temperature becomes needless, and a quantity of the purged gas is greatly reduced or a continuous monitor becomes needless.

Embodiment 3

Further, the auto-oxidizable deoxidizing material loses its deoxidization function when the materials oneself is oxidized. Then, the operation that it is substituted with a fresh deoxidizing material after using or the oxidized deoxidizing material is continuously reduced and processed to enable continuous using is necessary.

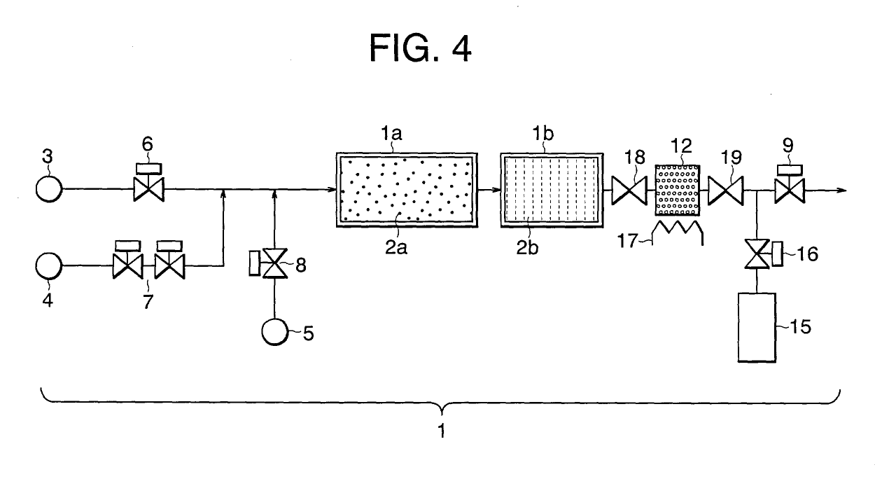

In order that the deoxidizing material can be changed, for example, as shown in FIG. 4, the deoxidizing means 12 may be separately received in a container and at front and back sides of the container, interception valves 18, 19 for exchange may be provided.

Note that, when the operation temperature of the catalytic reactor is the temperature sufficient enough to perform the reduction of the auto-oxidizable deoxidizing material, the deoxidizing material is only maintained in the catalytic reactor to enable repeated usage. Because, for example, in copper powders or iron powders oxidized mildly, the reduction reaction proceeds under equal to or more than around 200 to 300° C., the deoxidizing materials including the oxidized copper powders or iron powders, etc. as main components are automatically reproduced upon suspending and decreasing temperature of the device, by the reductive reaction gas that passes therethrough upon operating the catalytic reactor. That is, it can be repeatedly used without the special operation. Also, such a deoxidizing material does not have to be limited to the material commercially available as the deoxidizing material consisting of, for example, copper powders or iron powders, etc. The materials that react with oxygen at room temperature, and can remove the mixing oxygen concentration down to at least 1 mol % or less can be applied. For example, the catalyst in which minute copper-, iron-, and nickel-based etc. are supported on a porous organization (for example, a copper-based shift catalyst) can be applied as the deoxidizing material according to reactivity with oxygen. The reactivity with oxygen or the reductivity of the deoxidizing material after the oxidation can be confirmed by general technique such as a thermobalance analysis method or a reaction test.

On the other hand, when the operation of the catalytic reactor is performed at a low temperature and the reducible temperature of the deoxidizing material is not reached, a recycle processing is possible while using the reductivity of the reductive reaction gas by regularly heating so as to increase the temperature of a corresponding portion up to the reduction temperature. For example, as shown in FIG. 4, by independently arranging the deoxidizing means 12 and further adding the temperature adjustment mechanism 17 (for example, a mechanism for heating by using a wasted heat or heat sources such as electric heater in a reaction system including the catalytic reactor), a reduction condition (predetermined temperature and time) decided by the deoxidizing material can be provided. Note that, in the present invention, like this embodiment, even if the deoxidizing means is provided separately from the catalytic reactor, a combination of the catalytic reactor and deoxidizing means is called a “catalytic reactor.”

Embodiment 4

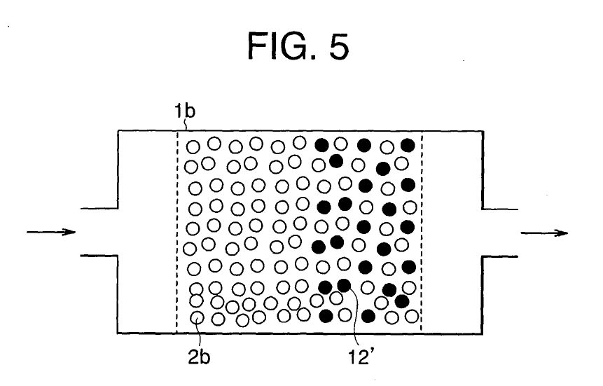

Also, in the above-mentioned embodiment, the example in which the catalyst and the deoxidizing material are separately provided is explained, but it is not always necessary that both are sectioned and supported. For example, as shown in FIG. 5, in the shift reaction portion 1b, the deoxidizing material 12′ may be introduced into the inside of shift catalyst 2b. The introduction can be easily achieved by merely mixing the catalyst and the deoxidizing material. In that case, it is desirable to fill as many deoxidizing materials as possible on an upstream side of an oxygen invasion path, oxygen is captured by the adjacent deoxidizing material 12′. As a result, in an embodiment of FIG. 5, the shift catalyst can be protected with simple and cheap structure without especially providing partitions sectioning the catalyst and the deoxidizing means. Some shift catalysts can be also used as the deoxidizing material as described earlier. When the shift catalyst 2b used in the shift reaction portion 1b is, for example, the copper-based shift catalyst and the catalyst is also available as the deoxidizing material, an effect similar to that in the example shown in FIG. 5 can be obtained by adding the shift catalyst of the quantity required as the deoxidizing material to a catalyst quantity required in the shift reaction in the latter half of the shift reaction portion 1b. Still in this case, the function of the shift catalyst demanded as the deoxidizing material is a deoxidizing performance at room temperature and a reduction of the catalyst after the oxidation at the catalyst operation temperature (for example, around 200° C.).

Embodiment 5

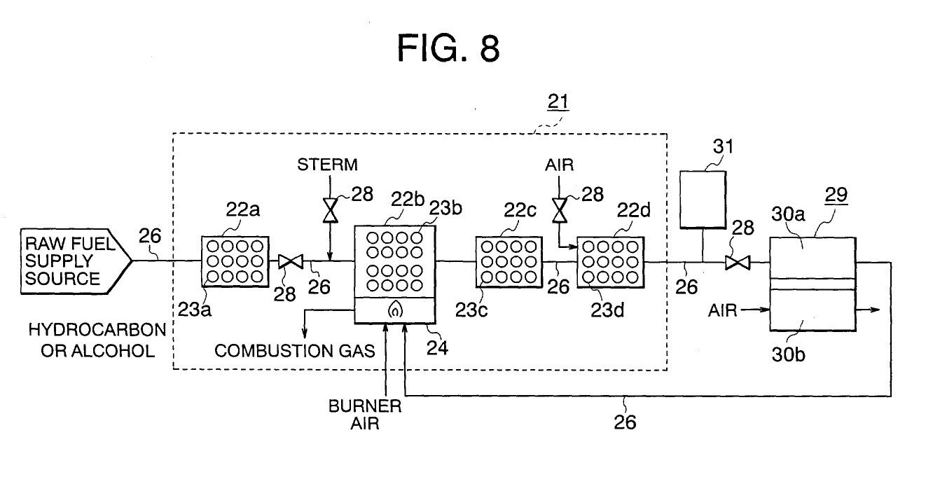

FIG. 8 is a block diagram showing the constitution on the periphery of to the fuel processing device of the fuel cell power generation system in accordance with Embodiment 5 of the present invention. In FIG. 8, a fuel processing device 21 has a catalytic reaction portion consisting of a desulfurization portion 22a, a reforming catalytic reaction portion 22b, a shift catalytic reaction portion 22c and a carbon monoxide removal catalytic reaction portion 22d. In the respective catalytic reaction portions, a desulfurization catalyst 23a, a reforming catalyst 23b, a shift catalyst 23c and a carbon monoxide removal catalyst 23d are maintained. A combustion portion 24 to give a reaction heat is provided in the reforming catalytic reaction portion 22b, and, further, the fuel processing device 21 has a fuel gas conduit 26 through which a raw fuel or a fuel gas is passed, and an opening and closing valve 28 provided between fuel gas conduit 26 and a fuel cell device 29. Then, a fuel cell power generation system has the fuel cell device 29 having a fuel gas flow passage 30a through which the fuel gas flows into the inside and an oxidant gas flow passage 30b, and a gas storage device 31 having the elasticity for storing the fuel gas.

In a power generation operation, the raw fuel consisting of hydrocarbon raw materials of LNG, etc. (as a representative component, methane) or an alcohols from a raw fuel supply source is supplied in the fuel processing device 21. As for the supplied raw fuel, after a sulfur component is removed by the desulfurization portion 22a, in the reforming catalytic reaction portion 22b using, for example, a steam reforming reaction, the original fuel mixed with steam is brought into contact with the reforming catalyst 23b under the high temperature (for example, 600 to 800° C.), and converted to the reformed gas including hydrogen as a main component (steam reforming reaction).

About 10 to 15 mol % of carbon monoxide (a dry gas standard) is normally included in the reformed gas. The carbon monoxide has a characteristic for poisoning an electrode catalyst for a mixing gas of a low temperature operation type fuel cell, for example, a phosphoric acid fuel cell (PAFC) or a polymer electrolyte fuel cell (PEFC). Then, in the power generation system using the PAFC, the shift catalytic reaction portion 22c (operation temperature: around 200 to 400° C.) in which the carbon monoxide concentration in the reformed gas is reduced to the allowable level by the cell (for example, about 0.5 mol %) is connected on the downstream of the reforming catalytic reaction portion 22b.

In PEFC, a poisoning tendency of carbon monoxide is still more remarkable, and it is necessary to reduce carbon monoxide down to 10 to 50 ppm or less. In this case, the carbon monoxide removal catalytic reaction portion 22d (generally, a selective oxidation type carbon monoxide removal reaction portion with the operation temperature of around 100 to 300° C.; and another type, there is also a methanation type carbon monoxide removal reaction portion for removing carbon monoxide by methanation) is further connected on the downstream of shift catalytic reaction portion 22c. The hydrogen-rich fuel gas from which carbon monoxide is removed to the low concentration is passed through the opening and closing valve 28 under the open state and supplied to the fuel cell device 29 on the downstream to be supplied in power generation.

The fuel processing device 21 includes these plural reaction portions (reforming catalytic reaction portion 22b, shift catalytic reaction portion 22c or carbon monoxide removal catalytic reaction portion 22d) as the core, and in addition thereto, includes appropriately others, a heat exchange portion, a steam generation portion, a desulfurization portion 22a, a combustion portion 24 to give reaction heat, etc., and is the device for generating hydrogen-rich gas (the fuel gas) from the raw fuel such as hydrocarbon or alcohol.

The above-mentioned various catalytic reaction portions included in the fuel processing device 21 are catalytic reaction portions each having a catalyst promoting reaction. The catalyst is usually obtained in such a manner that an active metal is maintained on the comparatively stable carrier such as ceramic, and it is necessary for the metal to be kept in a reduction state. The reforming catalyst 23b is a catalyst in which, for example, an active metal such as nickel or ruthenium is dispersely maintained in a ceramic carrier of alumina. Similarly, the shift catalyst 23c is a catalyst in which copper, platinum, or the like that is an active metal is dispersed on zinc oxide or alumina. The selective oxidation catalyst or methanation catalyst 23d is a catalyst in which platinum or ruthenium is maintained on a ceramic carrier.

The operation is explained next. The fuel cell power generation system in which a raw fuel is a natural gas (methane) and the fuel cell device 29 is the PEFC is explained as follows. In the fuel processing device 21, upon the normal power generation, the natural gas is subjected to the following processing. After the sulfur component contained therein is removed with the desulfurization portion 22a, the methane and steam (water) of mixture raw materials receive the reforming reaction, the shift reaction, and the selective oxidation type carbon monoxide removal reaction, respectively, in each of catalytic reaction portions 22b, 22c and 22d in turn to convert the natural gas into the hydrogen-rich fuel gas including hydrogen as a main component and carbon monoxide having concentration of around 10 ppm or less.

The hydrogen-rich gas as the generated fuel gas is supplied into the fuel gas flow passage 30a of fuel cell device 29 via the fuel gas conduit 26 and the opening and closing valve 28 (upon the normal power generation, open state). Simultaneously, air as an oxidant gas is supplied into the fuel cell device 29 for a cell reaction, hydrogen and oxygen are converted into water through electrochemical reaction, and on that occasion a power is generated in the fuel cell device 29. The fuel exhaust gas including unused hydrogen in the fuel cell device 29 is introduced via the conduit 26 to combustion portion 24. In the combustion portion 24, an unused combustible component is burnt with air in the fuel cell device 29, and a combustion heat that is accordingly generated is supplied as a reforming reaction heat in the reforming reaction portion 22b.

In the fuel cell power generation system in this embodiment, the gas storage device 31 is connected under communicated state on the way of the fuel gas conduit 26 that connects the fuel cell device 29 to the fuel processing device 21. In power generation operation, the fuel gas including hydrogen as a main component is passed through the adjacent fuel gas conduit 26, and the gas storage device 31 shows a back pressure (pressure) to balance with a pressure loss of instruments or conduits located on the downstream side from the above position in pressure. The gas storage device 31 is a flexible container using laminate film consisting of multi-layer structure of, for example, aluminum foil and polymer film (for example, polyethylene) here. Then, when this power generation system is operated, for example, in atmospheric pressure, the gas storage device 31 expands with an internal pressure of around 1.05 to 1.1 atmospheric pressure, and the hydrogen-rich fuel gas according to pressure is stored as it is therein. In this embodiment, as explained later, the fuel gas stored with the gas storage device 31 is utilized as gas for compensating the pressure reduction contraction of inside gas of the catalytic reaction portion.

Next, the operation at the time of suspending the system is as follows. Upon suspending the operation of the system, the catalytic reaction portions 22b, 22c, and 22d and the gas storage device 31 are put in a sealed state because the plural opening and closing valves 28 to connect them and the outside are all closed. Afterwards, each reaction portion starts a temperature drop, and in prior art taking no particular device, internal pressure will change into a pressure reduction condition by a capacity change of gas with a decrease of temperature. For example, in case of the reforming catalytic reaction portion, the pressure falls to about 1/2.7 only by a temperature effect when average temperature of reaction portion is supposed to be around 550° C. (the average value of low temperature portion 400° C. and high temperature portion of 700° C.) and temperature drops down to the normal temperature upon suspending the operation. Furthermore, about 30% steam is included in the reformed gas, and the pressure decreases to around 1/1.5 by the condensation of steam. That is, the pressure falls to around 0.2 atmospheric pressure when the reformed gas as an inflammable gas is sealed, and left to stand alone.

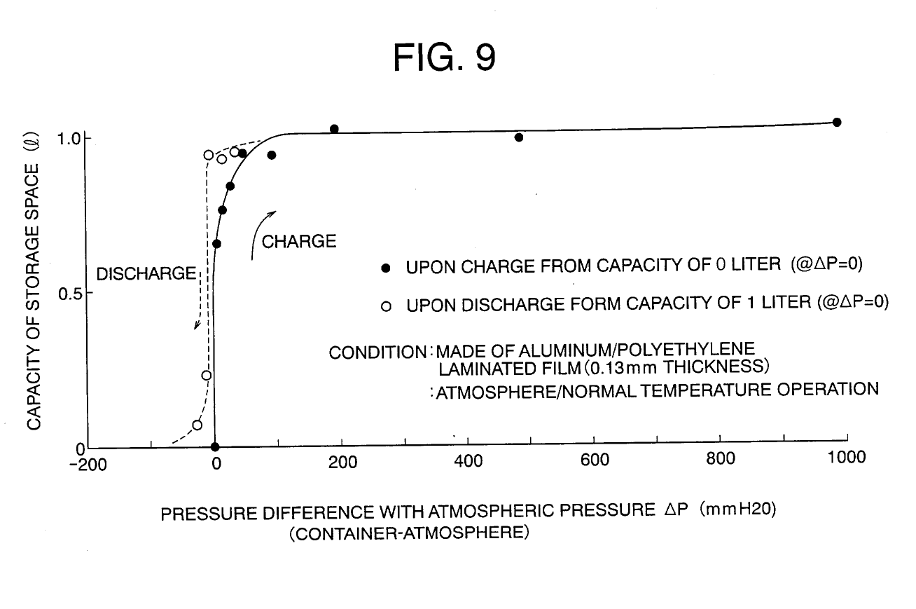

However, in this embodiment, because the elasticized gas storage device 31 is included in the sealed space, the elasticity of the gas storage device 31 follows a capacity change of the inside gas, and a pressure reduction condition is prevented. For example, the relation between a pressure to capacity change of the gas storage device 31 made with aluminum laminate film having thickness of 0.13 mm and a sufficient flexibility (a capacity of 1 liter) is shown in FIG. 9. In the gas storage device 31, as shown in FIG. 9, the capacity sufficiently swells out by the difference in pressure of around 0.005 atmospheric pressure (50 mmH₂O) higher than the atmosphere, and adversely by negative pressure 0.002 atmospheric pressure (20 mm H₂O) lower than the atmosphere, almost completely deflates.

This elasticized gas storage device 31 is connected to a space including predetermined reaction portion to constitute a sealed space. By this, a capacity of the gas storage device 31 automatically follows the capacity change of inside gas with a temperature drop, based on a pressure adjustment function of the gas storage device 31, and the replenishment of the purged gas etc. or monitor operation of pressure becomes needless. Besides, the gas storage device 31 is profitable to the catalyst activity protection since a catalyst space is kept under a hydrogen gas atmosphere originally existing inside the gas storage device 31.

Note that, there are two important points in which the present invention shows a sufficient effect. At one point, the absorbable capacity in the gas storage device 31 should be equal to or more than that affect the capacity change of gas in the catalytic reaction portion or conduit portion. The capacity change of gas can be predicted by actual measurement or roughly estimating a capacity change by the temperature or condensation based on state equations of gas.

Another point is a selection for the elasticity of the gas storage device 31. Primarily the gas storage device 31 has to withstand the maximum pressure upon the normal operation, etc. as the structure thereof. Incidentally, when the gas storage device 31 shown in FIG. 9 first was applied in a system of structure as shown in FIG. 8, the maximum pressure was about 1.07 atmospheric pressure, and the burst pressure of the gas storage device 31 by the aluminum laminate film is 1.5 atmospheric pressure. Secondly, the difference in pressure is necessary to fill or discharge gas in or from the gas storage device 31. When it is built in the system, this difference in pressure is equivalent to a pressure reduction value of the sealed space. When it is built in the system, as materials with higher flexibility are used, a needed pressure reduction value becomes smaller, and an air absorption risk becomes small.

That is, the elasticity of the gas storage device is decided by the usage condition, the required level of the withstand voltage or the allowable level of the pressure reduction. For example, as the available materials, in the descending order of flexibility, an airtight polymer film, a metal and polymer laminate film, and a metal foil sheet are given. The gas storage device 31 using polymer film or laminate film shows poor resistance to pressure but has a large elasticity, the use (charge/discharge) of the stored gas without substantially decompressing is possible.

On the other hand, when the gas storage device is made with the metal foil sheet, though the strength (withstand pressure) increases generally, it is necessary to permit some pressure reductions. For example, when a box body is formed of stainless steel sheets having a thickness of 0.1 mm, a pressure reduction value is about 0.02 atmospheric pressure as an example and becomes higher compared with that made of polymer film or laminate film.

In this way, the fuel cell power generation system of this embodiment has the fuel processing device 2 in which the raw fuel supplied from a raw fuel supply source is reformed to the fuel gas by a catalyst, the fuel cell device 9 in which the fuel gas generated by the fuel processing device 21 is caused to flow into the fuel gas flow passage 30a, the oxidant gas supplied from the outside is caused to flow into the oxidant gas flow passage 30b, and the fuel gas and the oxidant gas are chemically reacted to generate an electricity, and the fuel gas conduit 26 provided between the fuel processing device 21 and the fuel cell device 29 for passing the fuel gas therethrough. The fuel cell power generation system further has a plurality of opening and closing valves 28 provided at predetermined places of the fuel gas conduit 26, for sealing at least the predetermined catalytic reaction portions 22b, 22c and 22d of fuel processing device 21 and allowing a communication thereof, and the gas storage device 31 communicated with the sealed or communicable space, for absorbing a pressure change of the fuel gas in the sealed and communicable space and for storing the fuel gas.

That is, the fuel cell power generation system of this embodiment provides the opening and closing valves 28 on the distribution path 26 of the fuel gas in the fuel processing device 31 or the conduit 26 through which the raw fuel or the fuel gas is circulated, predetermined catalytic reaction portions 22b, 22c and 22d of the fuel processing device 21 are sealed and made communicable, and the elasticized gas storage device 31 is connected to sealed space including these catalytic reaction portions 22b, 22c and 22d.

Further, because the elasticized gas storage device 31 is accessibly arranged to the catalytic reaction portions of fuel processing device 21, even if gases in sealed spaces including catalytic reaction portions 22b, 22c and 22d exhibit volume change, the gas storage devices 31 automatically follow the change to absorb changes of capacities and pressure reductions in sealed spaces are prevented. As a result, an unmanned temperature decreasing process of the system can be carried out, and replenishment of the purge gas at the time of decreasing temperature or suspending operation becomes unnecessary as well.

Also, in the fuel cell power generation system of this embodiment, the sealed and communicable space does not include the fuel gas flow passage 30a of fuel cell device 29. Thus, upon suspending the operation of the system, an electrode catalyst of the fuel cell disposed adjacent to the fuel gas flow passage can be protected to improve the reliability of the system.

Also, the gas storage device 31 is manufactured by one of an airtight polymer film, a metal and polymer laminate film in which polymer film and metal sheet are bonded in a multi-layer and a metal thin film sheet and has the elasticity. Therefore, the gas storage device has a function enough to absorb the pressure change, and can have high reliability at low costs.

Embodiment 6

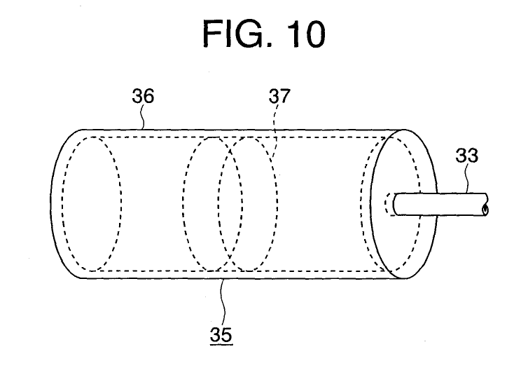

FIG. 10 is a perspective view of a gas storage device explaining the fuel cell generation system in accordance with Embodiment 6 of the present invention. In FIG. 10, a gas storage device 35 of this embodiment has a cylindrical hollow pipe 36 having a bottom, a short columnar piston 37 slidably provided inside this hollow pipe 36 for forming a sealed space whose capacity is changed by moving inside the hollow pipe 36, and a fuel gas connecting conduit 33 communicating between the fuel gas conduit 26 and the sealed space changing its capacity. Between a circumferential portion of the piston 37 and the hollow pipe 36, silicon grease is charged, and the piston 37 can move inside the hollow pipe 36 by very small frictional resistance while sealing the circumferential portion. In this way, by forming the sealed space by the piston 37 reciprocated inside the hollow pipe 36, the capacity of the gas storage device 31 automatically follows a capacity change of inside gas with a temperature drop, based on a pressure adjustment function of the gas storage device 31, and replenishment of the purged gas, etc. and monitor operation of pressure becomes needless.

In the fuel cell generation system of this embodiment, the gas storage device 35 stores gas in the sealed space changing the capacity formed by the piston 37 sliding inside the hollow pipe 36 and the hollow pipe 36. Thus, a function enough to absorb a pressure change is obtained.

Embodiment 7

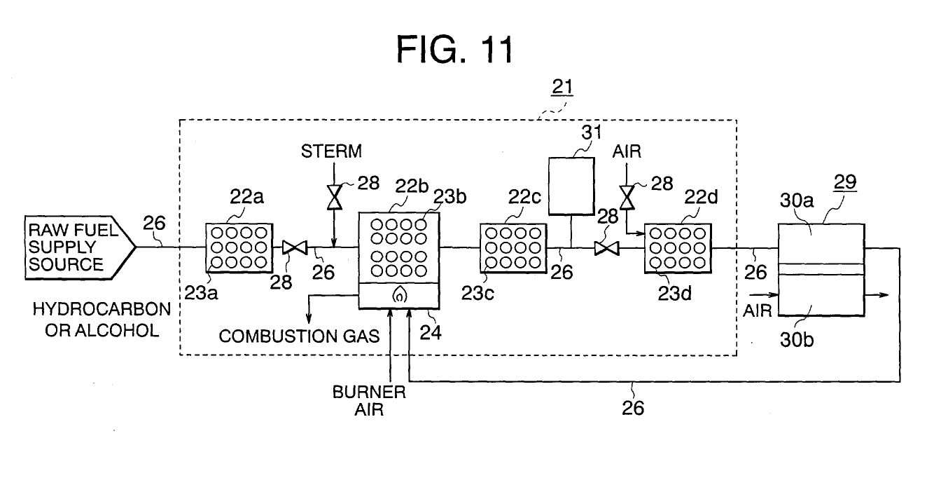

FIG. 11 is a block diagram showing the constitution on the periphery of the fuel processing device of the fuel cell generation system of Embodiment 7 of the present invention. In Embodiment 5 as shown in FIG. 8, all of the reforming catalytic reaction portion 22b, the shift catalytic reaction portion 22c and the carbon monoxide selective oxidation catalytic reaction portion 22d in the fuel processing device 21 are separated with the opening and closing valves 28 to form the sealed and communicable space, but this is not always needed. As for the catalyst causing no problem even if exposed to the air, it is possible to exclude the catalytic reaction portion from the sealed and communicable space. Such an example is shown in this embodiment. For example, in the platinum or alumina catalyst which is a representative carbon monoxide selective oxidation catalyst, the operation temperature is as low as and around 200° C., so that even if, during temperature drop, it is exposed to the air, there arises no serious problem in performance. Then, in this embodiment, to prevent air from mixing therein upon decreasing the temperature and suspending the operation, as the catalytic reaction portions, the reforming catalytic reaction portion 22b and shift catalytic reaction portion 22c are selected, the opening and closing valves 28 are installed on the front and back sides, and the sealed and communicable spaces are formed.

In the fuel cell generation system of this embodiment, the sealed and communicable space includes the reforming catalytic reaction portion 22b for reacting the reforming catalyst to the fuel gas and the shift catalytic reaction portion 22c for reacting the shift catalyst to the fuel gas among the catalytic reaction portions of fuel processing device 21. Thus, the catalytic reaction portion that causes no problem even if the catalyst is exposed to air is excluded from the sealed and communicable space, which can realize the minimum space to be sealed and accessible, so that the device can be simplified at low costs, and can improve its reliability.

Embodiment 8

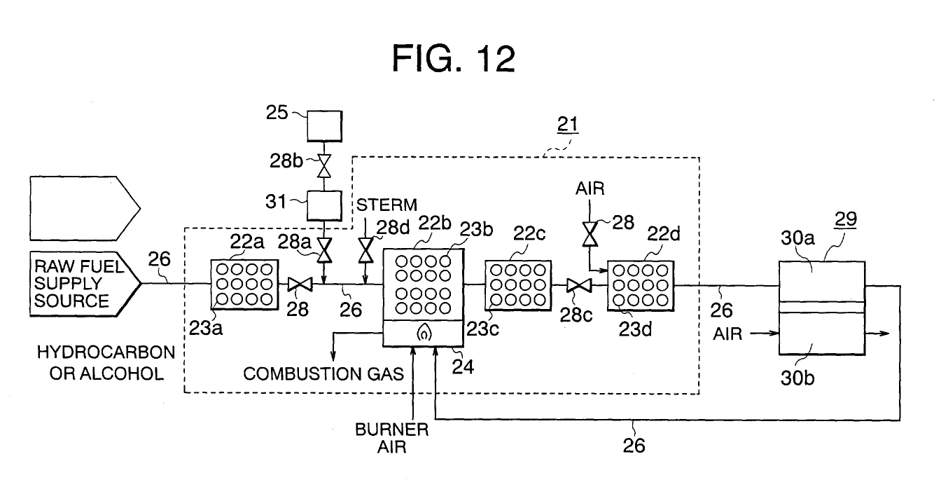

FIG. 12 is a block diagram showing the constitution on the periphery of the fuel processing device of the fuel cell power generation system of Embodiment 8 of the present invention. This embodiment takes constitution nearly identical to that of Embodiment 7 shown in FIG. 11, but a nitrogen purge line is further added to the fuel processing device 21.

When from a point of view of security upon suspending the operation, substitution with the inert gas in the reaction portion or the conduit is desired or the catalyst is adversely affected by the moisture physically upon safekeeping at a low temperature, the system is purged by the inert gas at the time of suspending operation. This embodiment is the case in which the present invention is applied to such a generation system. In this embodiment, the opening and closing valve 28b provided between the opening and closing valve 28a (the second opening and closing valve) adjacent to the gas storage device 31 and the inert gas supply device 25 is an open state upon suspending the operation, and from the inert gas supply device 25 through the gas storage device 31 the inert gas (for example, nitrogen, carbon dioxide, and argon) is introduced into a catalytic reaction portion space to be substituted with gas, for example, the reforming catalytic reaction portion 22b and the shift catalytic reaction portion 22c.

After an inflammable gas in the reaction portion space is purged, the opening and closing valve 28b on a purge supply side, and the opening and closing valve 28c on a purged gas outlet side are closed to form a sealed space. At this time, the opening and closing valve 28a is an open state, and the reaction portion space and the gas storage device 31 become the sealed space together. The system is then completely intercepted (for example, an operation power supply is turned off), and temperatures of various reaction portions 22b, 22c, and 22d are decreased.

The function of the inert gas is to stably maintain materials of catalysts, etc. under the gas atmosphere because of characteristics free from oxidization or combustion supporting property or to safely substitute gas without burning the combustion gas. As the representative kind of gases, nitrogen, carbon dioxide, argon, etc. are known broadly. In terms of cost, nitrogen or carbon dioxide can be cheaply used, and besides, the combustion exhaust gas in which nitrogen and carbon dioxide are main components can be applied by controlling the remaining oxygen in the exhaust gas of combustion portion 24 to the low concentration.

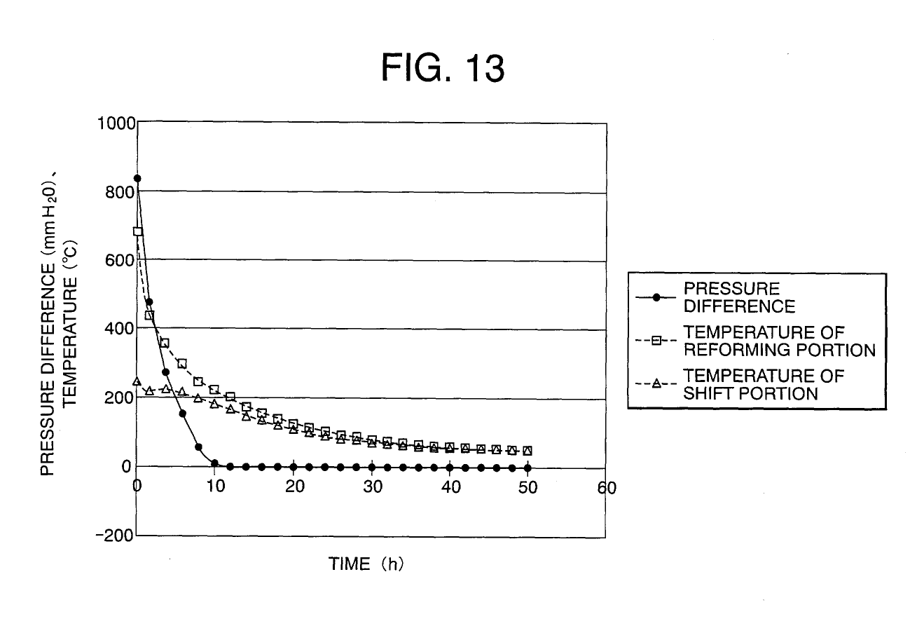

In this embodiment, the result of test that is made for examining internal pressure of the space which can be sealed and the temperature drop conditions of main reaction portions is shown in FIG. 13. In this embodiment, as shown in FIG. 13, the internal pressure of about 1.08 atmospheric pressure (as pressure difference with the atmosphere, 0.08 atmospheric pressure; 800 mm H₂O) is observed just after nitrogen purge in suspending operation, but after it, internal pressure falls according to a temperature drop. The difference in pressure between atmosphere and the inside of the space (shift catalytic reaction portion) that can be sealed is not observed roughly 10 hours later, but, after it, the pressure is not substantially reduced in this embodiment (the negative pressure from atmosphere is 0.0005 atmospheric pressure or less at maximum, and the pressure is not further reduced by the value or more).

In this way, in this embodiment, though the inert gas in the sealed reforming catalytic reaction portion 22b or shift catalytic reaction portion 22c contracts in volume by a decrease of temperature, as the capacity of the gas storage device 31 changes volume following the contraction, the space which can be sealed does not substantially take negative pressure. That is, the monitor of internal pressure or additional supply of the inert gas is unnecessary, and the stability of a catalyst is maintained by simple and easy operation. Also, the opening and closing valve of normal specification can be used because it is always free from fear of negative pressure. That is, the special valve which is superior in gas sealing property or the specification that withstands back pressure is unnecessary.

Note that, in this embodiment shown in FIG. 12, an example to introduce the inert gas into the catalytic reaction portions 22b, 22c, and 22d through the gas storage device 31 is explained. This is not always necessary from a purpose of the present invention, and, for example, the inert gas supply device 25 can be directly connected to the fuel gas conduit 26 through the opening and closing valve 28b. However, in the constitution shown in FIG. 12, it has a feature that the fresh inert gas is always stored in the gas storage device 31, and there is an advantage that it can be used for the protection of the catalyst inside the catalytic reaction portion safely. In a case of directly connecting the inert gas supply device 25 to the fuel gas conduit 26, it is necessary to pay an attention to opening and closing timings of the opening and closing valves 28a, 28b so that the steam does not flow backward into the gas storage device 31 from the fuel gas conduit 26.

Note that, in the above description, though the feature has been explained in the operation that the power generation system in this embodiment is stopped and temperature is decreased, the following feature is given at the time of activating the system or increasing temperature. About a process of increasing temperature from the activation to the power generation, the consideration regarding oxidation prevention of a catalyst similar to the case upon decreasing temperature is necessary. Also, there is a problem in that internal pressure increases by thermal expansion of internal gas, the desorption of absorption gas, or condensate evaporation when temperature is raised under a sealed state. This is a reverse phenomenon upon decreasing temperature, and pressure easily rises to reach the one two times the pressure at the room temperature.

Because, in the prior art, a mechanism to absorb a rise of internal pressure has not been included, the inert gas is generally introduced from the early time of the rise of temperature upon the activation to rise temperature, and in this way, the rise of internal pressure is prevented and a backflow of air to catalytic reaction portion is thus prevented. Then, after the rise of the temperature using the inert gas, when temperature of catalytic reaction portion becomes the temperature suitable for introduction of reaction gases, it was changed to reaction gases (hydrocarbon or alcohol class and steam) in turn.

On the contrary, in the present invention shown in FIG. 11 or FIG. 12, as the gas storage device 31 to absorb thermal expansion of gas inside the catalytic reaction portion is possessed, a rise of temperature of the system is possible under the sealed state of the reaction portion. Reaction gases (raw fuel and steam) are then introduced when temperature of the catalytic reaction portion rises to temperature suitable for introduction of the reaction gases. That is, in the present invention, the rise of temperature or the decrease of temperature without using the inertgas becomes possible, and a quantity of use of the inert gas can be made substantially zero. To determine whether the inert gas supply device 25 is maintained or not as the system, the study, or the like about safe security upon emergency is additionally necessary, but uselessness becomes possible with respect to the rise and decrease of temperature. That is, simplification of purge gas or gas lines becomes possible.

Also, in an embodiment of FIG. 12, as the inert gas is purged upon decreasing temperature, the catalytic reaction portion 22 or the gas storage device 31 is already filled with the inert gas upon the activation. Therefore, according to this embodiment, the rise of temperature without supply of the inert gas under the inert gas atmosphere is possible, and while omitting a supply of the inert gas upon rise of temperature that is conventionally necessary, the stable operation equivalent to the conventional case can be realized.

Note that, in the above-mentioned embodiment, an example in which one gas storage device 31 is provided in the fuel processing device 21 is explained, but this is not always needed. That is, a plurality of gas storage devices 31 may be arranged, and, for example, the gas storage devices 31 each discretely corresponding to the reforming catalytic reaction portion 22b, and the shift catalytic reaction portion 22c may be provided. Also, on that occasion, the opening and closing valves 28 corresponding to each gas storage device 31 may be added between catalytic reaction portions to form and use a plurality of sealed and communicable spaces, through the division.

Also, in the above-mentioned embodiment, the fuel gas flow passage 30a of fuel cell device 29 is excluded from the sealed and communicable spaces including the catalytic reaction portion of the fuel processing device 21 and the gas storage device 31, but whether the fuel gas flow passage 30a is included or not does not matter when judging from a purpose of the present invention. However, generally from a viewpoint of protecting the electrode catalyst (installed adjacent to the fuel gas flow passage 30a) of fuel cell 29, the fuel gas is generally purged from the fuel gas flow passage 30a upon suspending the operation. Therefore, in an embodiment of FIG. 8 or FIG. 10 including no inert gas purge, excluding the fuel gas flow passage 30a from the sealed and communicable space is desirable. On the other hand, in an embodiment of FIG. 12 including a purge by the inert gas, whether the fuel gas flow passage 30a is included or not in the sealed and communicable space does not matter.

In the fuel cell power generation system of this embodiment, the second opening and closing valve 28a arranged on the fuel gas conduit 26 communicating the sealed and communicable space and the gas storage device 31 is further included. Thus, because a fresh inert gas is always stored in the gas storage device 31 without causing steam to flow backward into the gas storage device 31 from the fuel gas conduit 26 and the catalyst inside the catalytic reaction portion is protected, reliability of the system can be improved.

Also, the inert gas supply device 25 communicated with the sealed and communicable space, for supplying the inert gas to the space is further provided. Thus, gas can be purged by the inert gas at the time of suspending the system when substitution with the inert gas in the reaction portion or the conduit is desired at the time of suspending the system or a catalyst is physically affected by the moisture upon low-temperature safekeeping.

Also, the inert gas of the inert gas supply device 25 reaches the sealed and communicable space via the gas storage device 31. Thus, a fresh inert gas is always stored in the gas storage device 31, and the reliability of the system can be improved because a catalyst inside the catalytic reaction portion is protected.

Also, the inert gas is nitrogen, carbon dioxide or a mixing gas of both. Thus, the inexpensive and safe inert gas is realized.

Embodiment 9

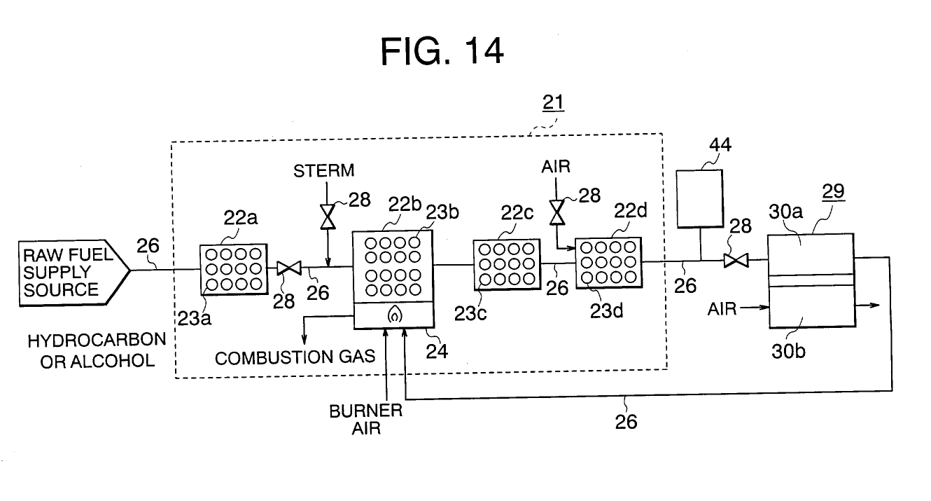

FIG. 14 is a block diagram showing the constitution on the periphery of the fuel processing device of the fuel cell power generation system of embodiment 9 of the present invention. This embodiment takes constitution nearly identical to Embodiment 5 shown in FIG. 8. However, a pressure adjustment device 44 is provided to adjust pressure of a gas in the sealed space to be the pressure outside the fuel processing device, instead of the gas storage device 31 of Embodiment 5 in which a change of pressure of gas in the sealed space is absorbed and the gas is stored. The pressure adjustment device 44 actually has the structure having a spring provided between the hollow pipe 36 and the piston 37 on the opposite side of side where the sealed space of the gas storage device 35 of FIG. 10 of Embodiment 6 is formed. Then, the pressure adjustment device 44 is so adjusted that the pressure of gas in the sealed space is a little higher than the external pressure. This slightly high level of the pressure does not cause a delay in original operation of the system.

In such a constitution of the fuel cell power generation system, even if gas in the sealed and communicable spaces including the catalytic reaction portions 22a, 22b, 22c, and 22d changes its volume, the pressure adjustment device 44 automatically adjusts pressure, and can prevent an inflow of air from the outside by increasing the internal pressure by only predetermined level higher than external pressure of the fuel processing device, and prevention of deterioration of the reforming catalyst becomes possible.

While the present invention has been particularly shown and described with reference to preferred embodiments, it will be readily appreciated to those of ordinary skill in the art that various changes and modifications in form and details may be made without departing from the spirit and scope of the invention.

It is intended that the appended claims be interpreted as including the foregoing as well as other similar changes and modifications.

What is claimed is:

1. A fuel processing device for converting a raw fuel fluid including hydrocarbon, alcohols, or ethers into a hydrogen fuel gas including hydrogen by a catalytic reaction, comprising one or more catalytic reactors each including a space maintaining a catalyst therein, the catalytic reactor including deoxidizing means formed of a deoxidizing material.

2. A fuel processing device according to claim 1, wherein:
the catalytic reactor has a fluid inlet portion and a fluid outlet portion; and
the deoxidizing material is provided between at least one of the fluid inlet portion and the fluid outlet portion and the space maintaining a catalyst.

3. A fuel processing device according to claim 1, wherein the deoxidizing material is introduced inside the space maintaining the catalyst.

4. A fuel processing device according to claim 1, further comprising a pressure adjustment mechanism capable of adjusting the pressure inside the catalytic reactor to be substantially identical to the pressure outside the catalytic reactor.

5. A fuel processing device according to claim 1, wherein the deoxidizing material is an auto-oxidizable deoxidizing material, and the device further comprises a temperature adjustment mechanism capable of adjusting the deoxidizing material at a predetermined temperature.

6. An operation method of a fuel processing device that converts a raw fuel fluid including hydrocarbon, alcohols, or ethers into a hydrogen fuel gas including hydrogen by a catalytic reaction and has one or more catalytic reactors each including a space maintaining a catalyst therein, the catalytic reactor including deoxidizing means formed of a deoxidizing material, the method comprising keeping the catalytic reactor in a sealed state when the fuel processing device stops an operation and maintaining the inside of the catalytic reactor under a reductive gas atmosphere.

7. An operation method of a fuel processing device that converts a raw fuel fluid including hydrocarbon, alcohols, or ethers into a hydrogen fuel gas including hydrogen by a catalytic reaction and has one or more catalytic reactors each including a space maintaining a catalyst therein, the catalytic reactor including deoxidizing means formed of a deoxidizing material, the method comprising keeping the catalytic reactor in a sealed state when the fuel processing device stops an operation and maintaining the inside of the catalytic reactor under an inert gas atmosphere.

8. A fuel cell power generation system comprising:
a fuel processing device for reforming a raw fuel supplied from a raw fuel supply source to a fuel gas by a catalyst;
a fuel cell device in which the fuel gas generated in the fuel processing device is allowed to flow into a fuel gas flow passage and an oxidant gas supplied from outside is allowed to flow into an oxidant gas flow passage to cause a chemical reaction between the fuel gas and the oxidant gas to generate an electricity;
a fuel gas conduit provided between the fuel processing device and the fuel cell device for circulating the fuel gas;
a plurality of opening and closing valves each provided at a predetermined place of the fuel gas conduit for changing at least a predetermined catalytic reaction portion of the fuel processing device between a sealed state and a state capable of communication; and
a gas storage device communicated with a sealed and communicable space for absorbing a change in the pressure of gas in the sealed and communicable space and for storing the gas therein.

9. A fuel cell power generation system according to claim 8, further comprising an inert gas supply device communicated with the sealed and communicable space, for supplying an inert gas into the space.

10. A fuel cell power generation system comprising:
a fuel processing device for reforming a raw fuel supplied from a raw fuel supply source to a fuel gas by a catalyst;
a fuel cell device in which the fuel gas generated in the fuel processing device is allowed to flow into a fuel gas flow passage and an oxidant gas supplied from outside is allowed to flow into an oxidant gas flow passage to cause a chemical reaction between the fuel gas and the oxidant gas to generate an electricity;
a fuel gas conduit provided between the fuel processing device and the fuel cell device for circulating the fuel gas;
a plurality of opening and closing valves each provided at a predetermined place of the fuel gas conduit for changing at least a predetermined catalytic reaction portion of the fuel processing device between a sealed state and a state capable of communication; and
a pressure adjustment mechanism communicated with a sealed and communicable space for adjusting the pressure of gas in the sealed and communicable space to be equal to or higher than the pressure outside the fuel processing device.

11. A fuel cell power generation system according to claim 10, further comprising an inert gas supply device communicated with the sealed and communicable space, for supplying an inert gas into the space.
